(19) United States
(12) Patent Application Publication
(10) Pub. No.: US 2001/0037719 A1
(43) Pub. Date: Nov. 8, 2001

(54) Digital sheet music display system

(76) Inventors: Gary L. Gardner, Chesapeake Beach, MD (US); Sara Conwell, Swarthmore, PA (US)

Correspondence Address: Richard C. Litman, LITMAN LAW OFFICES, LTD., P.O. Box 15035, Arlilngton, VA, 22215, US

(21) Appl. No.: 09/820,211

(22) Filed: Mar. 29, 2001

Related U.S. Application Data
(60) Provisional application No. 60/201,674, filed on May 3, 2000.

(51) Int. Cl. G09B 15/02

(52) U.S. Cl. 84/478

(57) ABSTRACT

A digital sheet music display system capable of storing and retrieving a large number of musical scores and capable of displaying a musical score in a format identical to paper sheet paper. The digital sheet music display system is lightweight and highly portable and provides the musician, music teacher, and music student with state-of-the-art technology right at their fingertips.

### CROSS-REFERENCE TO RELATED APPLICATION

This application claims the benefit of U.S. Provisional Patent Application Serial No. 60/201,674, filed May 3, 2000.

### BACKGROUND OF THE INVENTION

1. Field of the Invention

The present invention relates generally to electronic music displays. More specifically, the invention is a digital sheet music display system that provides a musician, music teacher, or music student with the convenience and performance of a personal computer contained in a package similar in dimensions to paper sheet music.

2. Description of Related Art

Musicians often live hectic and harried lives and anything that can bring some order and a little tranquility to their lives is greatly appreciated. Paper sheet music is a constant source of exasperation for a musician for a multiplicity of reasons. Paper sheet music can be voluminous to store and can be awkward to handle while performing. Paper sheet music can become worn from repeated use and brittle with age. When paper sheet music is placed on a music stand, it can be easily dislodged which causes some very anxious moments for the performer. Furthermore, nothing is more frustrating than thumbing through paper sheet music trying to find the desired music. Additionally, technological advances have resulted in rapid growth of software for computerized music lessons. Unfortunately, traditional personal computers often prove awkward for the musician to control while trying to concurrently handle a musical instrumental.

The prior art describes a variety of digital display systems used to display of a diversity of information including musical scores, for example, a musical score display and the method of displaying the musical score is described in U.S. Pat. No. 5,400,687, issued on Mar. 28, 1995 to K. Ishii. The musical score is displayed by a simple operation which permits the musical score to be easily seen when playing the music. Musical score data of a plurality of pieces of music is stored in the musical score display and when a piece of music is selected, the musical score data of the piece of music is read out and displayed. Thus, the musical score data is easily selected and displayed. Furthermore, musical score data that has been read out and displayed is changed according to a displayed musical score change instruction so that the displayed musical score can be changed without trouble while playing the music.

U.S. Pat. No. 5,467,102, issued on Nov. 14, 1995 to Y. Kuno, et al., describes a portable display device with at least two display screens that are controllable either collectively or separately. The portable display device is capable of presenting a document in an easy to read format in which a simultaneous display of the different parts of the document in reasonable sizes is made by a simple operation of the device. The display device consists of a document memory for storing documents to be displayed, at least two display screens for displaying the documents stored in the document memory means, and a display control unit for controlling displays of the documents on the display screens. When the control unit is in a linked mode, the displays on the display screens are linked together, and when the control unit is in separate mode, the displays on the display screens are independent from each other.

A networked electronic music display stand is described in U.S. Pat. No. 5,760,323, issued on Jun. 2, 1998 to E. Romero, et al. The electronic display stand is a multi-functional device that can be used for displaying other types of information besides music. The electronic display stand advances through musical notes without interrupting a musician's performance. The stand is controlled by either remote mechanical actuation or the sound of musical notes or a timed interval. The device has a display large enough to display a full page of sheet music at one time. A plurality of stands is networked to simultaneously display musical notes to a number of musicians.

None of the above inventions and patents, taken either singly or in combination, is seen to describe the instant invention as claimed. The digital sheet music display system of the present invention has numerous unique and innovative features not found in prior art digital display systems.

### SUMMARY OF THE INVENTION

Accordingly, it is a principal object of the invention to provide a digital sheet music display system that is as portable as paper sheet music and as powerful as a personal computer.

It is another object of the invention to provide a digital sheet music display system that is easy to use and maintain.

It is a further object of the invention to provide a digital sheet music display system that is capable of storing and retrieving a large number of musical compositions.

Still another object of the invention is to provide a digital sheet music display system that displays sheet music in a very useful and functional manner.

Further still, it is an object of the invention to provide a digital sheet music display system which is readily disposed on a conventional sheet-music stand.

It is an object of the invention to provide improved elements and arrangements thereof in a digital sheet music display system for the purposes described which is inexpensive, dependable, convenient, and fully effective in accomplishing its intended purposes.

To meet the above objectives, the present invention provides a digital sheet music display system that displays sheet music in a very useful, flexible, and functional format. The digital sheet music display system of the present invention is menu driven and readily guides the musician through the multitude of options available. The digital sheet music display system provides a portable console having a display screen and a set of controls disposed adjacent to the display screen.

The digital sheet music display system provides the musician with the convenience customarily associated with paper sheet music and the power and performance of a personal computer all in a single lightweight package. The digital sheet music display system is specifically designed to meet the unique needs of a musician. It is important to note that, with a computerized, digital display of sheet music, in many cases, it proves difficult and cumbersome for a musician to control a musical instrument, while concurrently attempting to control digital sheet music using a traditional P/C, mouse and keyboard. The Digital Sheet Music Display System's onboard, integrated keypad is uniquely designed to provide fingertip controls for quick and easy access to those particular functions that are most important to musicians (such as page changes and song score selections). Additionally, once a specific song score is selected and displayed on-screen, a special foot switch enables total “hands-free” control of paging.

Sheet music is displayed in a portrait configuration using a liquid crystal display (LCD) screen that is 8 ½ inches wide and 11 inches in height, similar to paper sheet music, making the sheet music easy to read. Fingertip touch button controls are disposed immediately adjacent to the display screen giving the digital sheet music display system a sleek, compact appearance. The digital sheet music display system provides easy to use line break and repeat options so that a musical score can be viewed by discrete pages or continuous scrolling, and so that preselected sections of the score may be viewed again without paging backward through each page of the score.

The digital sheet music display system operates and displays sheet music in either scanned image or MIDI (musical instrument digital interface) format. A musical composition can be readily converted from a scanned image format to MIDI format. The digital sheet music display system employs a built-in 120 MB super diskette drive that allows for retrieving a large number of archived musical compositions. In addition, the digital sheet music display system can also have an auxiliary built-in CD-ROM or read/write CD drive for storing and retrieving music scores. Power to the digital sheet music display system is supplied by either embedded batteries or an A/C adapter. A separate long play battery is optional.

The digital sheet display system is designed to be highly adaptable and to be extremely flexible. The display system can readily accommodate virtually any type of hardware interface, for example, the unit can interface with PCs, scanners, MIDI instruments, network servers, or external CD-ROM drives.

In a first embodiment, a two page unit, that folds like a book, has a folding double screen and a physical appearance very similar to paper sheet music. The first embodiment advances a musical score two pages at a time. In a second embodiment, a one page unit has a single screen and a physical appearance very similar to a single page of sheet music. The second embodiment advances a musical score one page at a time. In a third and fourth embodiment, the digital sheet music display system provides two distinct keyboard layouts for a controller/driver unit that connects to a user's own display screen. The difference between the third and fourth embodiments is that the third embodiment incorporates the keypad and computer (thus, the user provides the display screen), while the fourth embodiment provides the keypad and software (in this instance, the user provides both the computer and display screen, accordingly). The Digital Music Display System is a comprehensive tool, which is designed to perform a wide range of functions that will serve the needs of beginning music students, hobbyists, music teachers, music education institutions, professional entertainers, music composers and concert musicians.

These and other objects of the present invention will become readily apparent upon further review of the following specification and drawings.

### BRIEF DESCRIPTION OF THE DRAWINGS

FIG. 1 is a front view of a first embodiment of the digital sheet music display system having dual display screens according to the present invention.

FIG. 2 is a front view of a second embodiment of the digital sheet music display system having a single display screen.

FIG. 3A is a front view of a third embodiment of the digital sheet music display system that connects to a user's own display screen.

FIG. 3B is a front view of a fourth embodiment of the digital sheet music display system that connects to a user's own display screen.

FIG. 4 is a top view of a foot switch used to provide foot operated functions for page forward, page back, and repeat.

FIG. 5A is a side view of one side of the first embodiment of the digital sheet music display system showing the set of adjustments, controls, and peripheral connections on that side.

FIG. 5B is a side view of the opposite side of the first embodiment of the digital sheet music display system showing the set of adjustments, controls, and peripheral connections on that side.

FIG. 6A is a side view of one side of the third embodiment of the digital sheet music display system showing the peripheral ports and connections on that side.

FIG. 6B is a side view of the opposite side of the third embodiment of the digital sheet music display system showing the location of the super diskette drive.

FIG. 7 is a rear view of the third embodiment of the digital sheet music display system showing the peripheral ports and connections on that side.

FIG. 8 is a front view of the display screen showing a program option for the digital sheet music display system.

FIG. 9 is a front view of a display screen showing the line break option for the digital sheet music display system.

FIG. 10 is a front view of a display screen showing the repeat option for the digital sheet music display system.

FIG. 11 is a front view of a display screen showing a score selection for the digital sheet music display system.

Similar reference characters denote corresponding features consistently throughout the attached drawings.

### DETAILED DESCRIPTION OF THE PREFERRED EMBODIMENTS

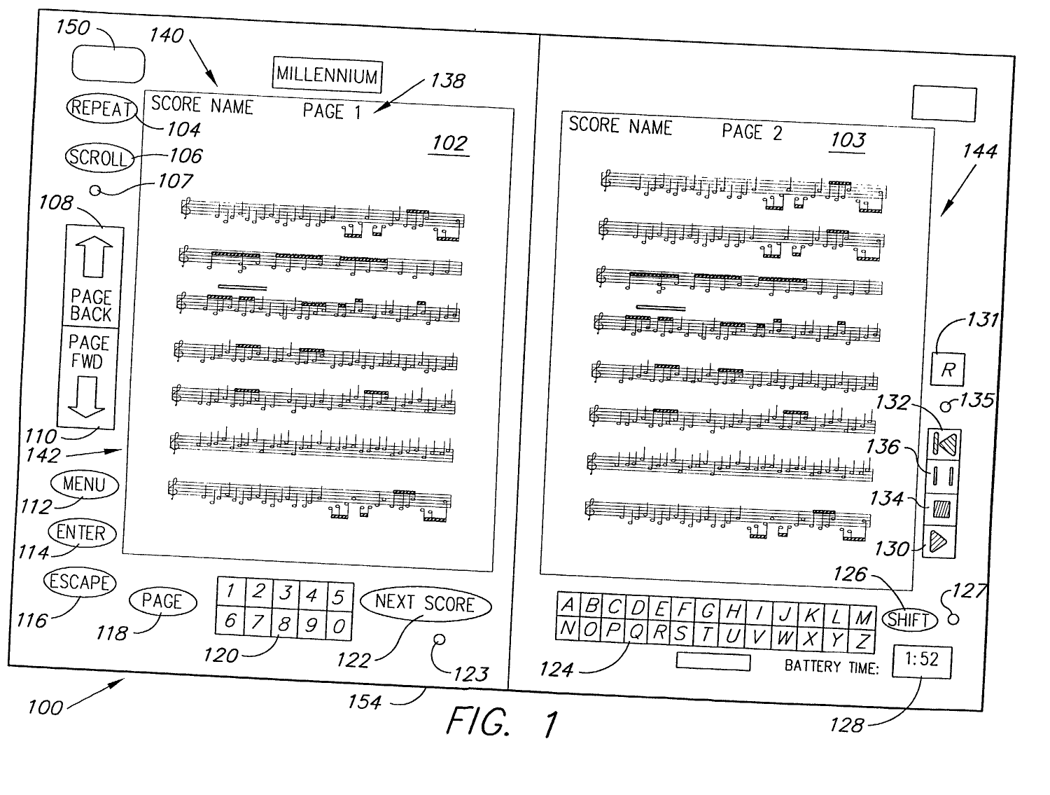

The present invention, as depicted in FIGS. 1-11, is a digital sheet music display system 100 that has the portability of paper sheet music and the versatility and power of a personal computer. The digital sheet music display system 100 of the present invention allows a musician to conveniently carry with him, his favorite and most frequently performed musical compositions. The digital sheet music display system 100 puts the power of the digital age at the fingertips of the musician. The digital sheet music display system 100 is designed to be similar in dimensions to paper sheet music and to have a compactness in the design of the display screen and control buttons that the digital sheet music display system 100 is readily disposed on a conventional music stand.

A first embodiment of the digital sheet music display system 100 is shown in FIG. 1. As can be seen in FIG. 1, the digital sheet music display system 100 has a compact design with a set of controls disposed immediately adjacent to the display screens 102, 103. Sheet music 142, 144 is displayed in a portrait configuration using a display screen 102, 103, preferably an LCD screen, in which each screen is 8 ½ inches wide and 11 inches in height, making the sheet music 142, 144 easy to read, the two screens 102 and 103 folding about hinges for compact storage. Upon turning the unit 100 on, a “Welcome” screen briefly appears for approximately 5 seconds. The system 100 then displays four choices:

Introduction & Tutorial,

Select a Song Now,

System Main Menu, and

Lyrics Library.

Selection of the “Introduction & Tutorial” option prompts the user to insert a specific disk (not shown) that contains an introduction, a tutorial, and a demo. Selection of the “Select a Song Now” option enables the user to bypass the “Main Menu” and directly displays the song list from the disk (not shown) currently in the unit's drive 200 from which the user selects a song. The “Select a Song Now” option displays a selection list where MIDI songs and image songs are grouped together according to mode (MIDI or scanned image). The songs are listed alphabetically by song name within each mode. Selection of the “Main Menu” option opens the main menu to all system functions. Selection of the Lyrics Library will enable users to bypass the Main Menu and immediately a lyrics file for display.

Special functions or Links via the System Main Menu will enable the user to create, edit and process the files in the Lyrics Library. For professional performers, the musical parts are very often memorized and the sheet music notation may, therefore, not be required; however, many performers have problems remembering the words. Additionally, it is not uncommon for vocalists to be disposed somewhat further away from the music stand/display than those persons who are playing a musical instrument. Thus, a “Lyrics Only” mode would enable just the lyrics of a given musical composition to be displayed in a selective sized font such as a larger font than if they were combined with standard sheet music notation. While the general display capabilities of the Digital Sheet Music Display System in both the Scanned Image and MIDI formats are fully capable of including Lyrics, Chord Diagrams, etc., the Lyrics Library provides enhanced utility by allowing users an alternative to display the Lyrics alone without combining the lyrics with a selective musical composition with standard musical staff notation.

Pressing the main menu key 112, 512 also causes the main menu (not shown) to be displayed. The main menu lists the major system functions, for example,

Search for a Music Score,

Scanned Image Processor, and

Convert Image to MIDI.

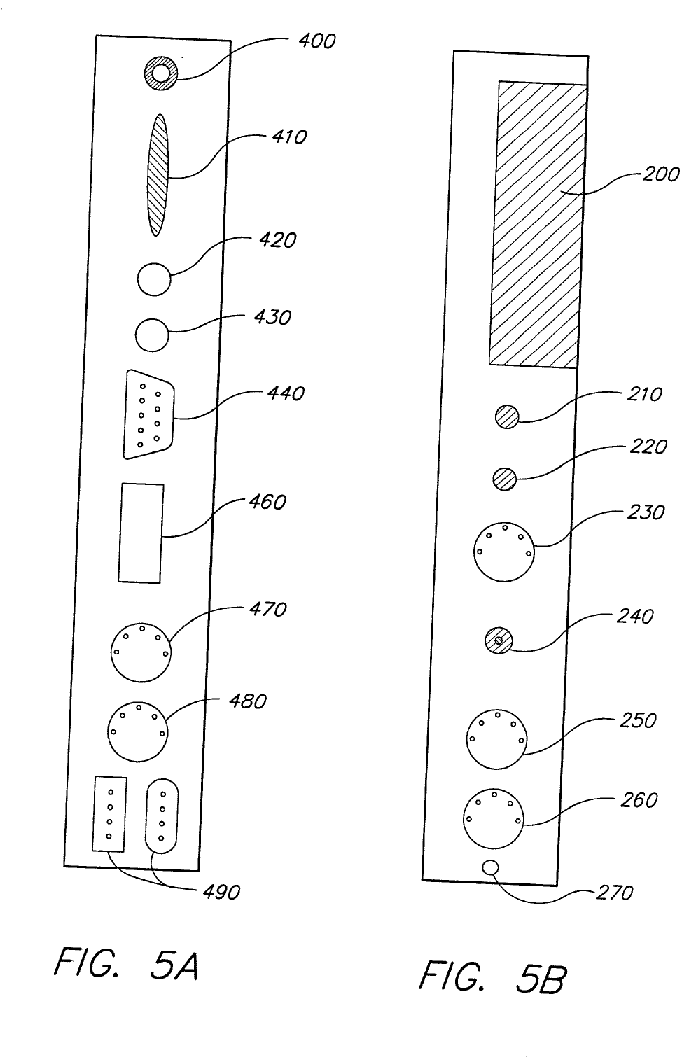

Using the page forward 110, 510 and page back 108 arrow keys, the user (not shown) moves the highlighter (not shown) to the desired sub-menu and presses the enter key 114, 514. For example, selecting “Search for a Music Score” from the main menu enables the user to locate and select a desired piece of sheet music 142, 144 on the specific diskette (not shown) in the unit's super diskette drive 200 (see FIG. 5B). If an internal or external CD ROM drive (not shown) is connected to display system 100, the user may highlight “CD (Drive D)” on the sub-menu to select the desired piece of sheet music 142, 144 from the CD ROM drive.

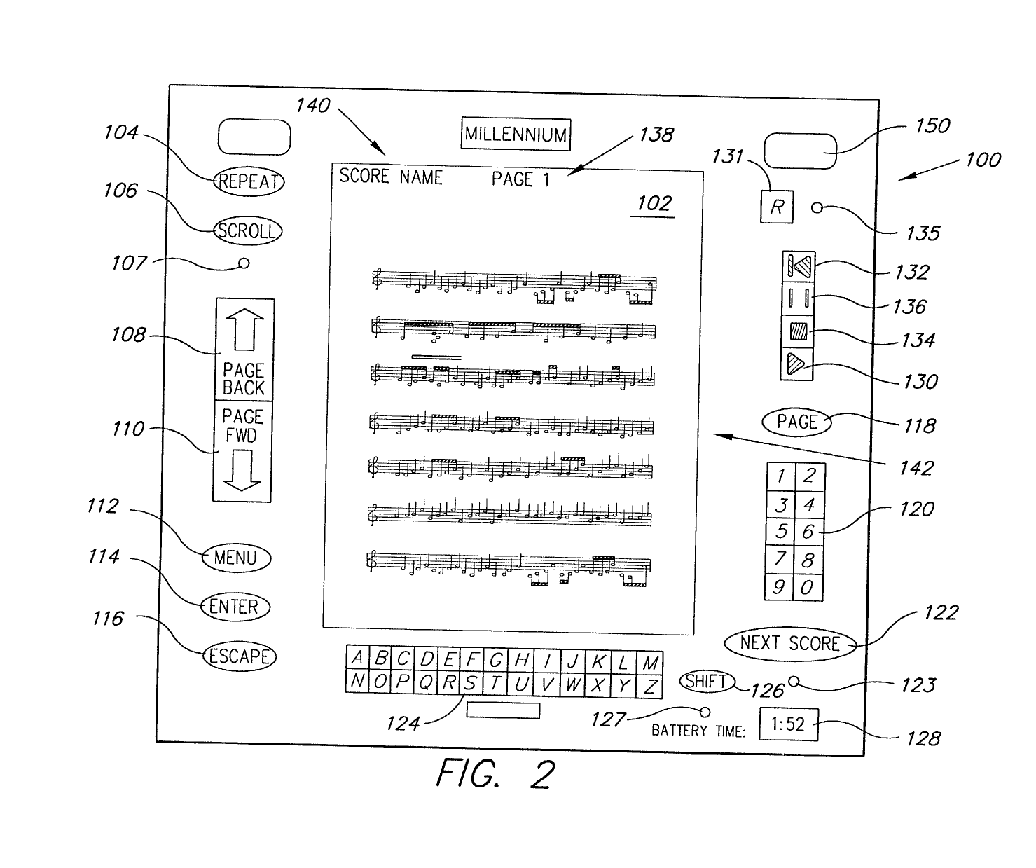

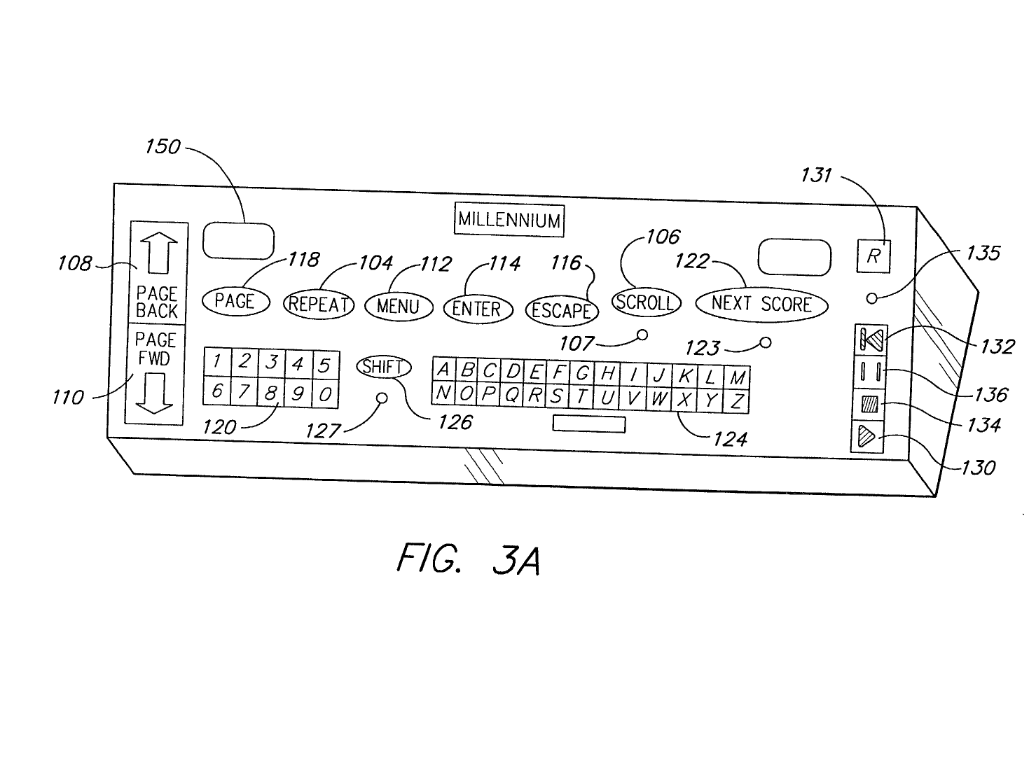

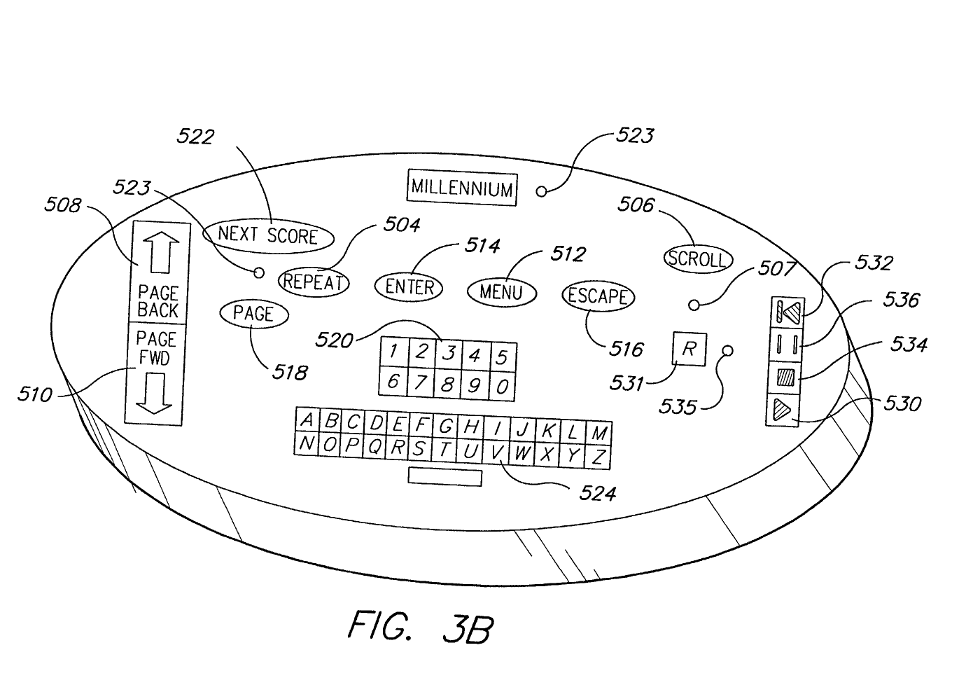

FIG. 2 is a front view of a second embodiment of the digital sheet music display system 100. The second embodiment employs a single display screen 102 and has the set of controls disposed immediately adjacent the single display screen 102. The set of control keys function the same as the control keys on the dual screen 102, 103 embodiment. FIGS. 3A and 3B are front views of a respective third and fourth embodiment of the digital sheet music display system 100. Each respective third and fourth embodiment of the digital sheet music display system 100 is a controller/driver 100 that connects to a user's own display screen (not shown). The controller/driver 100 has the same control keys as the first and second embodiments. With respect to the third and fourth embodiments depicted in respective FIGS. 3A and 3B, the key pattern layouts of the controller/driver are different. These differences serve to provide for greater utility for a respective user. Theses particular features together with software drivers and functions provided on CD-ROM, can be attached to, and interfaced with any Personal computer (PC) or laptop computer.

Once a specific piece of sheet music 142, 144 is selected and displayed, the system 100 automatically shows the score name 140 and page number 138 at the top of the screen 102, 103. The digital sheet music display system 100 operates and displays music in either a scanned image format or a MIDI (musical instrument digital interface) format. A special processor (not shown) helps the user to format and annotate scanned images of sheet music in order to enable unique features that enhance the utility of the music score in the image mode. The scanned image processor enables the user to trim scanned images and to enter annotations that enable special features of the system 100 to function. After processing, the user saves the completed scanned sheet music as a file.

In the image mode, the digital sheet music display system 100 is directly interfaced with any standard scanner (not shown) which enables the user to convert paper sheet music to digital music score. Once initial scanning and formatting is completed for the first page of sheet music, the user is given two choices by the system 100. The first choice is to continue to process the score in image mode, in which case, the system 100 prompts the user to annotate each page 142, 144 for the special functions of repeat and scroll. The system 100 displays a screen (not shown) on which the user elects whether or not to proceed with the entry of the line breaks 180 required to scroll.

As an alternative or adjunct to entering line breaks, the user may select “Roll”. The “Roll” function is, in fact a subset of Scroll. By electing Roll, the user employs the foot switch, which enables the user to; (a) select to advance the song score a set number of spaces (pixels) each time the foot switch is depressed or, (b) select to Roll continuous, meaning that the displayed score will roll forward (or back) as long as the foot switch remains depressed. This means that the musician can be playing with both hands on a musical instrument, while advancing the song score with the foot; a considerable improvement over conventional sheet music display techniques.

The other choice is to automatically convert the scanned image score to MIDI format, in which case, the special annotations required for image mode are not applicable. With either option, the user completes initial scanning for all pages of a particular song before going to the next step in the process which is either annotation or conversion to MIDI format.

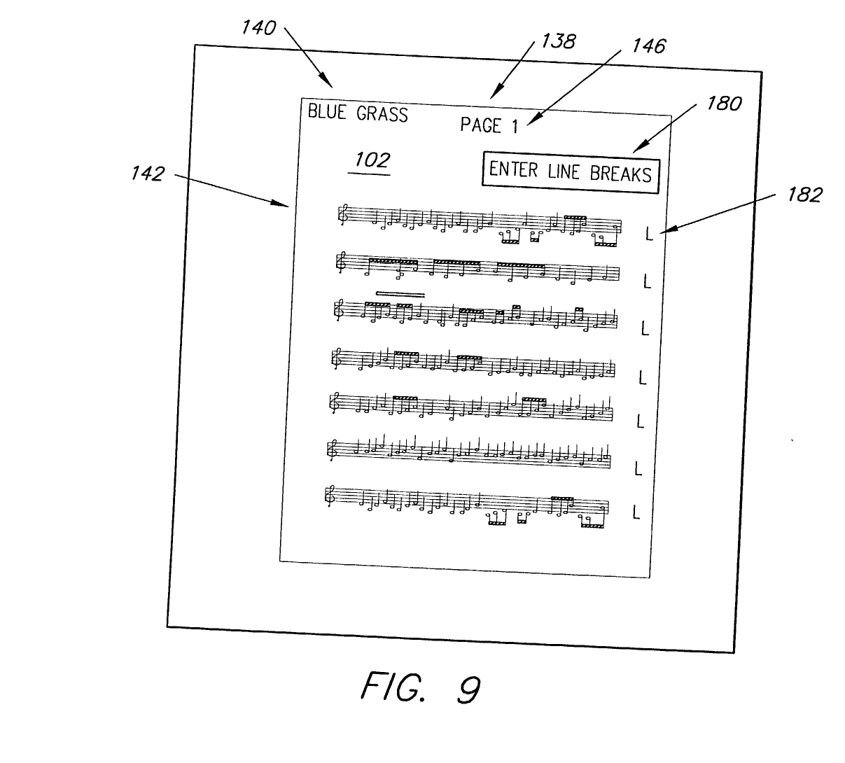

The scroll function key 106, 506 enables the user to scroll continuously through a music score line-by-line rather than page-by-page. When the user selects scroll, the page forward and page back keys (108, 508), (110, 510) and the foot switches 190 are used to move the music score forward or back one line at a time. Scroll operates on a single screen 102 only. When the scroll function is activated, a yellow light 107, 507 below the scroll key 106, 506 is illuminated. The scroll function requires the user to first input line breaks, as indicated by the prompt 180. This is required because with a scanned graphic image of a sheet music page 142, the computer program does not know where the line breaks 180 are unless they are manually entered. Using the page forward and page back keys (108, 508), (110, 510) the user simply moves the cursor to the spaces between the lines of music and depresses the enter key 114, 514. This annotates the page 142 and creates a letter “L” icon 182 on the music score 142 denoting each line break 180 as depicted in FIG. 9.

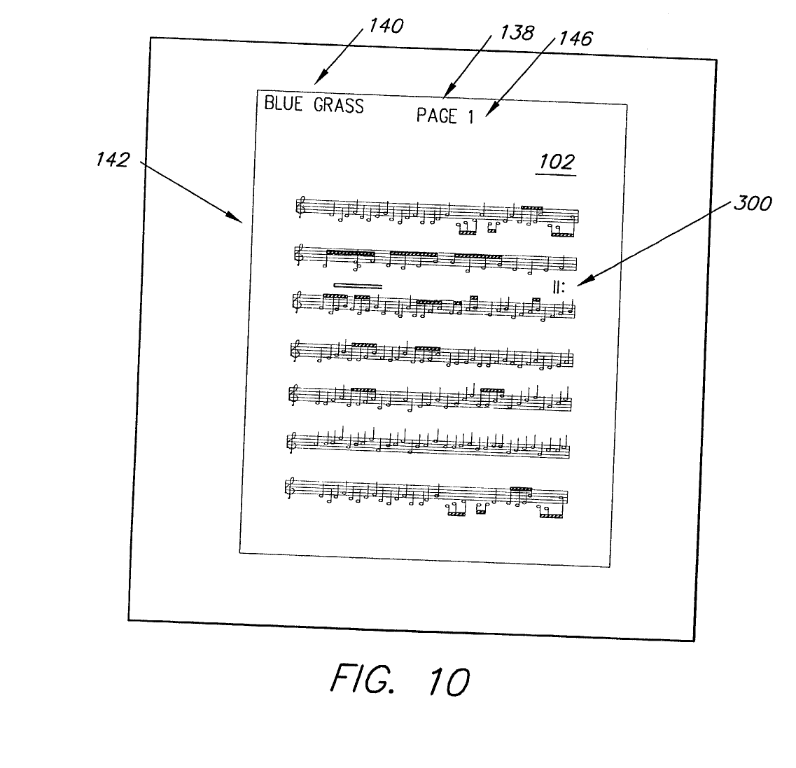

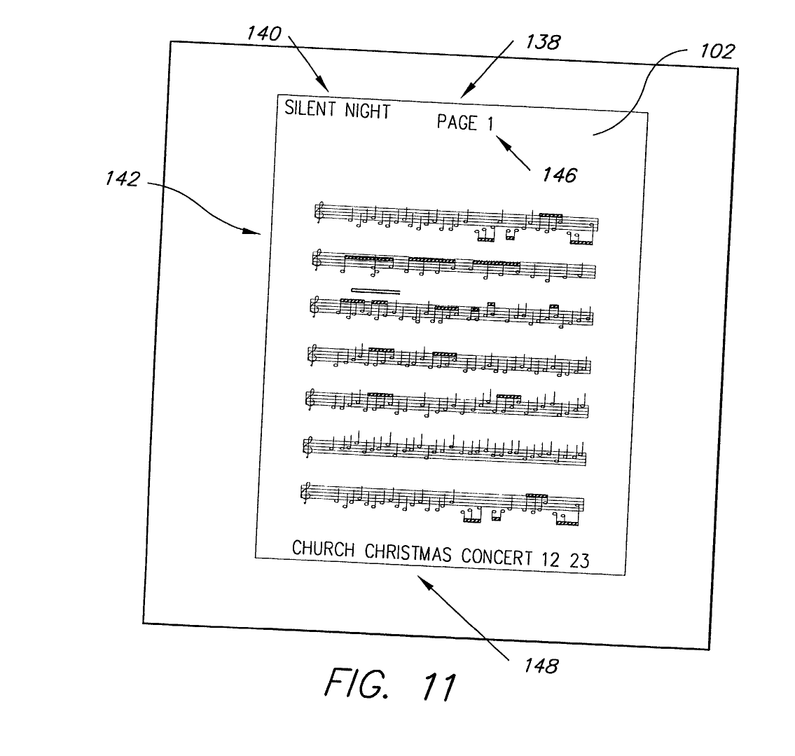

The second of the special functions requiring annotation is the “repeat” function. A repeat sign 300 (which is common) tells the musician to return to an earlier place in the music score such a place denoted by its own repeat sign 300) and to replay the section of music between the two signs. The repeat button 104, 504 returns the display 102 to the location within the current music score that contains the last beginning repeat sign 300. A special computer based repeat sign 300 must be entered whenever there is a beginning repeat sign 300 within the music score 142 as shown in FIG. 10. This is so that the computer program is able to recognize the location and return the display 102 to the specific page (or line) 142 of the music that contains the last beginning repeat sign 300 when the user hits the repeat key 104, 504 or repeat foot switch 194. Once a music score is annotated with the special repeat signs 300 and the user activates repeat, not only will the display 102 return to the desired location within the music score 142 but the repeat sign 300 at that location flashes making it easy for the musician to see.

In order for the scroll function to properly operate, the user must enter the repeat icon 300 just before any line that contains a beginning repeat sign 300. The system 100 displays each page of the song score 142 and the user simply moves the cursor arrow (not shown) down the screen 102 depressing the repeat key 104, 504 when the cursor is just before any line containing a beginning repeat sign 300. Once this has been done, when the scroll function is activated and the console repeat button 104, 504 or the foot switch repeat button 194 is depressed, the display 102 goes back to the specific line of music in the score 142 that contains the last previous beginning repeat sign 300.

If the option to “Enter Line Breaks” to support scroll is not selected, entering of the repeat signs 300 is still required for the repeat feature to function on scanned images. However, in this case, depressing the console repeat key 104, 504 or the foot switch repeat button 194 returns the display 102 to the last full page containing a beginning repeat sign 300 as opposed to the specific line in scroll mode.

A conversion program converts a musical score from a scanned image format to a MIDI format. The conversion program is run at the completion of the scanning of the pages of a song score or the conversion program is activated directly from the main menu and applied to scanned sheet music files in the superdiskette drive 200, for example, the user selects a previously scanned image score from a diskette (not shown) and converts it to MIDI.

MIDI sheet music 142, 144 can be played back by the user's computer (not shown) and the user can select a musical instrument of his or her choice for playback. Furthermore, the user can play along as the user's computer plays back a musical score 142, 144. MIDI sheet music 142, 144 highlights the notes on the score 142, 144 as they are being played back. Selecting “Select MIDI instrument” from the main menu produces a pull down menu listing the various MIDI instrument sounds available from which the user chooses for playback.

The resolution and graphic quality of MIDI sheet music 142, 144 is both high and consistent, and the user can control the tempo during playback. When in MIDI mode, a standard set of control keys (130, 530), (132, 532), (134, 534), (136, 536) is provided for easy playback and include play 130, 530, rewind 132, 532 stop 134, 534 and pause 136, 536. These control keys (130, 530), (132, 532), (134, 534), (136, 536) are only active when the system 100 is in the MIDI mode. In addition to the player (not shown), the system 100 is also equipped to record MIDI or wave audio. The user selects “Record/audio” from the main menu. Actual recording is initiated by depressing the record button 131, 531 and the adjacent indicator light 135, 535 is illuminated. In MIDI mode, the user can connect to a MIDI instrument and record a song while it is being played and save it in MIDI format. The notation is subsequently edited and later displayed on the system 100 as a song score.

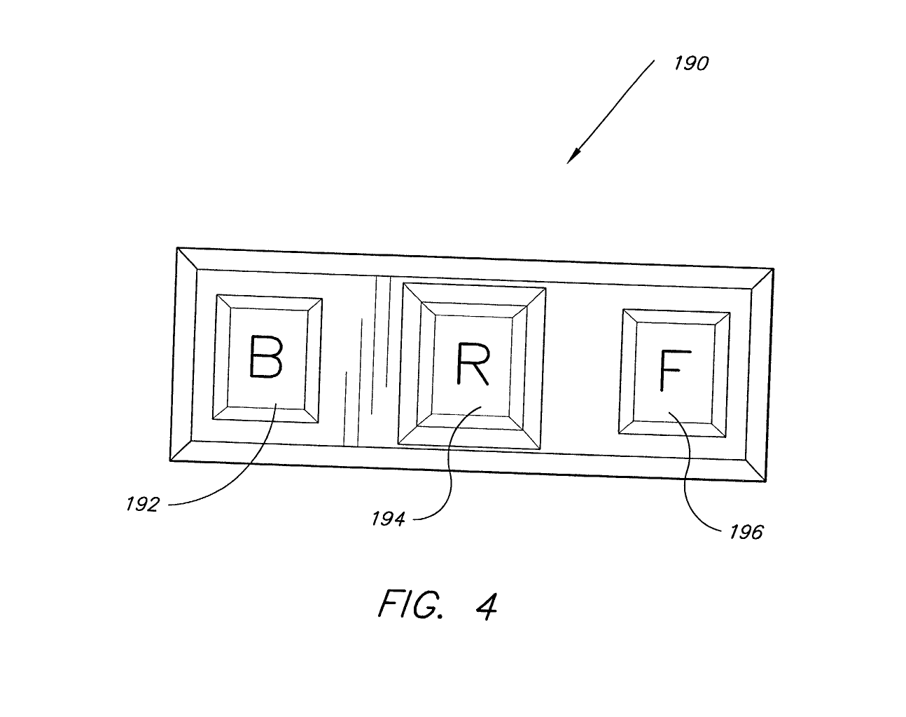

Once a specific musical score 142 is selected and displayed on the display screen 102, the page forward arrow key 110, 510 and the page back arrow key 108, 508 are used to move the display to the next page or to the previous page in the single display screen 102 embodiment and in the controller/driver embodiment. In the dual display screen 102,103 embodiment, the page forward and back backward arrow keys (108, 508), (110, 510) move two pages at a time. FIG. 4 is a top view of an optional three button foot switch 190 used to provide foot operated functions for page forward 196, page back 192, and repeat 190. Using this feature, the user's hands are free at all times while playing a song. The center switch 194 on the foot control 190 is raised so that the user feels the correct foot button without having to look down. The page forward, page back, and repeat functions are simultaneously available from either the buttons (104, 504), (108, 508), (110, 510) on the display unit 100 itself or from the foot switch 190.

The page function key 118, 518 enables the user to use the numeric keypad 120, 520 to select any page from the current score. When the user depresses the page button 118, 518, a box (not shown) appears in the page number area 146 at the top of the screen 102. The new page number appears on the screen 102 as the user types it in the page number area 146 at the top of the screen 102. The user then presses the enter key 114, 514 and the desired page appears on the display screen 102.

As an alternative, the user selects “program page sequence” from the main menu. This special function allows the user to preprogram the page flow sequence of a particular score so that the page forward key 110, 510 or foot switch 196 is used instead of the page function key 118, 518 during the playing of a song. For example, if the user plays up to page 11 of a particular song score, and the next movement of the song contained on pages 12 through 20 is skipped, in other words, the user jumps from page 11 to page 21, the user sets this page sequence in advance. Once this has been done, depressing the page forward key 110, 510 or the foot switch forward button 196 at the end of page 11 automatically brings up page 21.

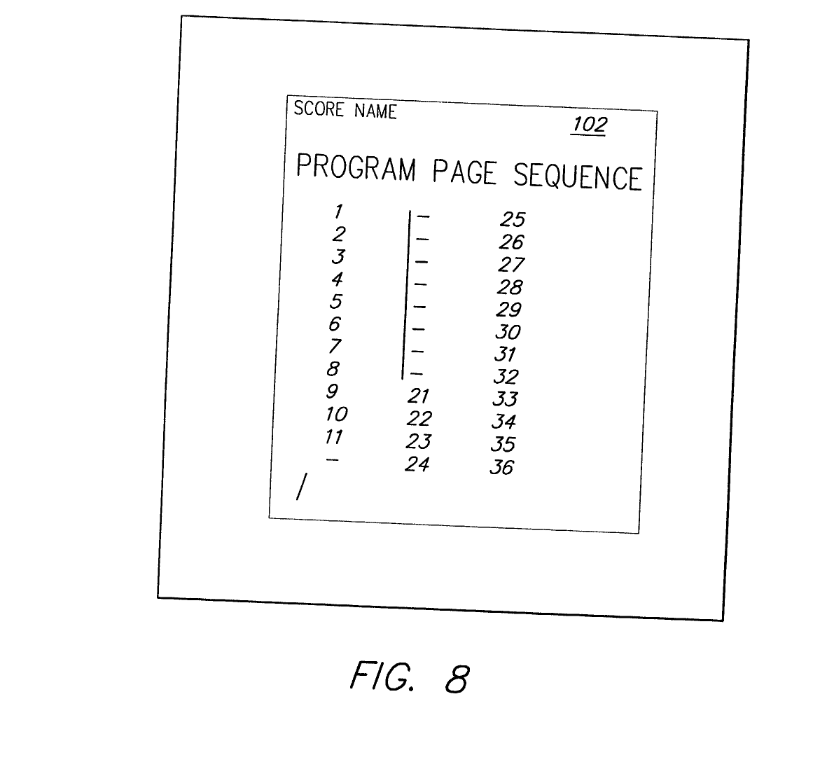

FIG. 8 shows the display screen 102 for the above program page sequence selection. This option is useful in cases where the desired order of the page sequence is other than the regular consecutive numerical order or where large blocks of pages are to be skipped.

Selection of “Concert Functions” from the main menu enables the user to select a series of music scores in advance and to place them in sequential order in accordance with a planned concert. Thus, the selection of “Concert Functions” enables the user to either “Plan a Concert” or “Select a Concert.” Furthermore, the selection of the “Concert Functions” activates the next score key 122, 522 and illuminates the next score light 123, 523. When the next score key 122, 522 is depressed, the first page of the next score in the preprogrammed concert sequence is displayed. The user does not have to go back to the main menu at the end of each musical number in the concert in order to search for or to select the next score to be played. The user simply depresses the next score key 122, 522 and the next score in the concert sequence is automatically displayed on the screen 102.

The system 100 first prompts the user to enter the name of the concert. The user enters the name of the concert using the alphabetic and/or numeric keypads (120, 520) and (124, 524). A shift key 126, 526 provides for upper case letters and a shift light 127, 527 is illuminated when the shift key 126, 526 is active. After entering the concert name, the user enters the names of the song scores in the order in which they are to be played in the concert. As an alternative to typing in the name of a song score, the user has the option to depress the menu key 112, 512 to display the main menu. The function “Search for a Music Score” from the main menu is used to locate and identify a song score to be included in the concert.

When in “Plan a Concert” mode, the system 100 displays a message at the bottom of the song list stating “to add song to concert, press enter.” The song score name is added and the display 102 automatically returns to the concert planning entry screen 102. Under “Select a Concert,” the user has two options. The first is “Enter Concert Name” and the second is “List Concerts” which displays a list of concert names from which the user can choose. Once a particular concert name is entered or selected from the list, the first page of the first music score in that concert is displayed on the screen 102. The name of the concert is displayed in the lower right center 148 of the page 142. Concurrently, this activates the next score key 122, 522 on the display 102 and the next score light 123, 523 is illuminated.

Selection of the “Super Diskette Drive” item from the main menu produces a sub-menu. The sub-menu covers a number of super diskette functions which include formatting, erasing, displaying a file index, and copying.

The function on the main menu entitled “Run a Tutorial” is an excellent tool for tutorials and music lessons. The dual display screen 102, 103 embodiment is preferred for music lessons because it enables teaching and instructional information and materials to be displayed on one screen 102 while the actual related sheet music 142 is displayed on the other screen 103. With the single screen 102 embodiment as well as with the controller/driver unit embodiment, the screens 102 cascade in the traditional way. However, both the single screen embodiment 102 and the controller/driver embodiment also enable the user to run tutorials prepared for the dual display screen 102, 103 embodiment by toggling back and forth between the instructional materials page and the sheet music page to which it refers. With both the single screen 102 embodiment and the controller/driver embodiment, in the tutorials mode, the next score key 122, 522 functions as a toggle switch.

Software is available that enables tutorials to be produced using the dual display screen 102, 103 embodiment with instructional content on one page 142 and sheet music on the other page 144. Each embodiment of the digital sheet music display system 100 is fully multi-media ready. Tutorials may include audio and video clips as well as graphic images and animation as an option, and the system 100 accommodates various types of multimedia plug-ins. Presentations or presentation blocks of less than 120 MB each are copied to super diskette using the unit's 120 MB super diskette drive 200. Alternatively, presentations of greater than 120 MB are run directly from an internal CD-ROM drive or from an external CD-ROM drive which is easily connected to the display system 100.

Selection of the “System Functions & Settings” from the main menu produces a sub-menu that lists all system software, hardware, and peripheral interface configurations and settings as well as all multimedia plug-ins. FIG. 5A is a side view of one side of the dual display screen 102, 103 embodiment and the single display screen 102 embodiment showing the set of adjustments, controls, and peripheral connections on that side. The adjustments, controls, and peripheral connections include ON/OFF 400, brightness 410, horizontal adjust 420, vertical adjust 430, serial port/interface 440, USB/scanner 460, MIDI IN 470, MIDI OUT 480, and Ext CD/ROM 490.

FIG. 5B is a side view of the opposite side of the dual display screen 102, 103 embodiment and the single display screen 102 embodiment showing the set of adjustments, controls, and peripheral connections on that side. The adjustments, controls, and peripheral connections include the super diskette drive 200, Mic 210, Line 220, Ext keyboard 230, A/C adapter and battery 240, Foot Switch 250, Mouse 260, and Earphone/Audio Out 270.

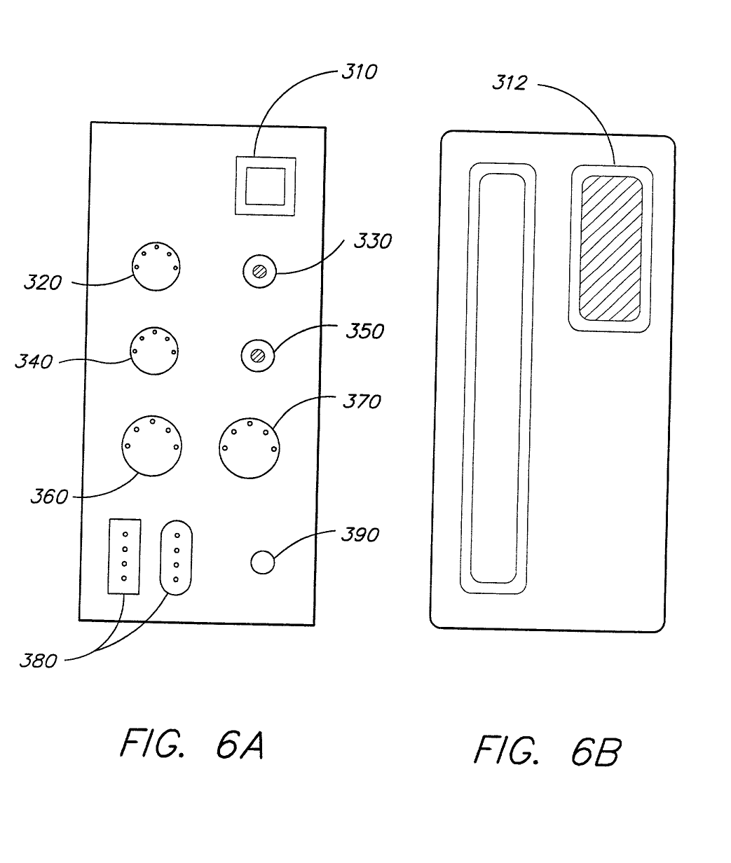

FIG. 6A is a side view of one side of the controller/driver embodiment showing the peripheral ports and connections on that side and the location of the power switch 310. The peripheral ports and connections include Mouse 320, Line 330, Ext Keyboard 340, Mic 350, MIDI IN 360, MIDI OUT 370, CD/ROM 380, and Phones 390. FIG. 6B is a side view of the opposite side of the controller/driver embodiment showing the location of the super diskette drive 312.

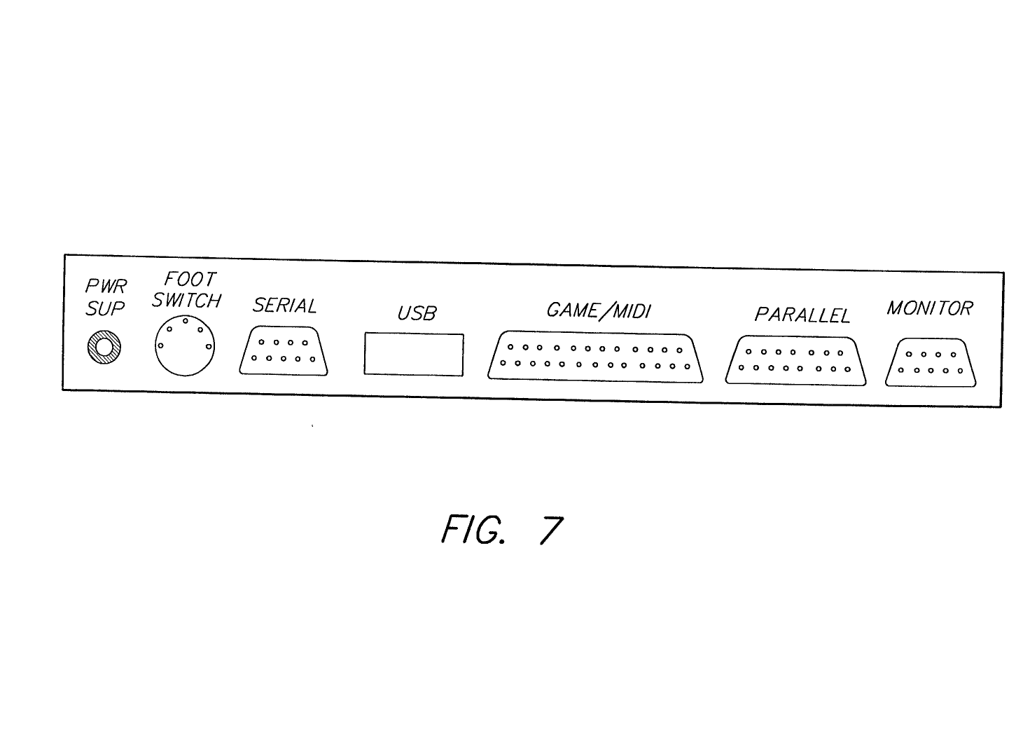

FIG. 7 is a rear view of the controller/driver embodiment showing the peripheral ports and connections on that side. The peripheral ports and connections include power supply, foot switch, serial, USB, parallel, Game/MIDI, and Monitor.

Each embodiment is equipped with two internal stereo speakers 150, 550 as well as with stereo earphone jacks 270, 390 and line out 220, 330. Like most laptops, the power supply (not shown) is available either from batteries or from A/C. Embedded batteries (not shown) run the unit 100 for up to two hours. An A/C adapter is provided with the unit 100. A separate powerful long play battery that runs the unit 100 for up to six hours and serves as backup is also available as an optional accessory.

When in battery mode, the unit 100 continuously displays the battery time remaining 128 and flashes a warning when the battery power runs low. When in the A/C power mode, the letters A/C appear in the “time remaining” window 128. All four embodiments include an internal CD-ROM drive as an option. An escape key 116, 516 is provided to restart the system 100.

In a preferred embodiment, the dual display screen 102, 103 embodiment is 14 ½ inches in height, 22 ½ in width, and 2 inches in depth and folds at a hinge 154 to become 14 ½ in height, 11 ½ inches in width, and 4 inches in depth. The single screen 102 embodiment is 13 inches in width, 14 ½ inches in height, and 2 inches in depth. The controller/driver embodiment that is used with a standard flat panel LCD display screen has a wedge shape or inclined configuration as depicted in FIG. 3A and is 14 inches in width, 2 inches in height at the front, and 5 inches at the back, and 9 inches in depth. Each embodiment comes in a specially designed carrying case which includes an A/C adapter and the optional foot switch 190.

The state-of-the-art digital sheet music display system of the present invention has a myriad of features that are especially designed to meet the unique needs of musicians, music teachers, and music students. The menu-driven digital sheet music display system clearly and carefully guides the musician through the use of the system which produces anxiety free use of the digital sheet music display system.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated.

It is to be understood that the present invention is not limited to the sole embodiments described above, but encompasses any and all embodiments within the scope of the following claims.

We claim:

1. A digital sheet music display system for displaying electronic images of sheet music, comprising:
a) a display monitor having a screen measuring at least 8 ½ inches in width and eleven inches in height for displaying sheet music;
b) a microprocessor electrically connected to said display monitor;
c) a memory means for storing software code and data;
d) computer software means stored in said memory means for providing instructions to said microprocessor for controlling the display of images on said display monitor;
e) input means for providing data and scanned images to said memory means; and
a power supply means for supplying electrical power to the system.

2. The digital sheet music display system according to claim 1, wherein said screen is a liquid crystal display screen.

3. The digital sheet music display system according to claim 1, further comprising:
a) computer software means for playing music in MIDI format; and
b) at least one speaker electrically connected to said microprocessor.

4. The digital sheet music display system according to claim 1, wherein said computer software means includes software code for displaying a sequence of pages of sheet music one page at a time, the system further comprising:
a) a page forward button adjacent the screen for advancing the display monitor through the sequence of sheet music one page at a time; and
b) a page back button adjacent the screen for moving the display monitor backward through the sequence of sheet music one page at a time.

5. The digital sheet music display system according to claim 1, further comprising a second display monitor hingedly attached to said first display monitor for displaying images of two pages of sheet music side by side.

6. The digital sheet music display system according to claim 1, further comprising a foot pedal electrically connected to said microprocessor and having at least one button for selecting an image to be displayed on said display monitor.

7. The digital sheet music display system according to claim 1, further comprising an adaptive console having a distinct geometric configuration.

8. The digital sheet music display system according to claim 7, wherein said geometric configuration is substantially rectangular.

9. The digital sheet music display system according to claim 7, wherein said geometric configuration is substantially elliptical.
